(19) United States
(12) Patent Application Publication
(10) Pub. No.: US 2007/0285436 A1
(43) Pub. Date: Dec. 13, 2007

(54) COLOR ADJUSTMENT METHOD AND RELATED DEVICE

(76) Inventors: Yen-Hsing Wu, Chudong Town (TW); Chun-Hsing Hsieh, Hsin-Chu City (TW); Chia-Hui Kuo, Chubei City (TW)

Correspondence Address: NORTH AMERICA INTELLECTUAL PROPERTY CORPORATION, P.O. BOX 506, MERRIFIELD, VA, 22116, US

(21) Appl. No.: 11/672,945

(22) Filed: Feb. 8, 2007

(30) Foreign Application Priority Data
Feb. 9, 2006 (TW) 095104399

(51) Int. Cl. G09G 5/02

(52) U.S. Cl. 345/604

(57) ABSTRACT

A color adjustment method for adjusting color characteristics of a display device includes: respectively utilizing a plurality of sets of digital color channel values to drive the display device, each set of digital color channel values respectively corresponding to a plurality of color channels; and regarding at least a portion of the sets of digital color channel values: respectively utilizing a plurality of candidate Gamma characteristics to drive the display device, and measuring colors displayed by the display device to generate a plurality of sets of candidate chromaticity coordinate values corresponding to the candidate Gamma characteristics; and selecting a set of target chromaticity coordinate values according to the sets of candidate chromaticity coordinate values, and determining a Gamma characteristic corresponding to the set of digital color channel values according to a target Gamma characteristic corresponding to the set of target chromaticity coordinate values to adjust the color characteristics.

### BACKGROUND OF THE INVENTION

1. Field of the Invention

The present invention relates to display devices, and more particularly, to color adjustment methods and related devices.

2. Description of the Prior Art

As various kinds of multimedia applications become popular, it is typically needed to transmit video data between different devices by utilizing color video signals. To perform transmission of color video signals through the Internet or between computers, sRGB specifications are introduced to provide a standard color space that can be commonly utilized in the art. As a result, all display/output devices complying with the sRGB specifications may perform data interchange without introducing color distortion. According to the sRGB specifications, a display device of 6500K color temperature may help a user to increase the accuracy of color calibration/tuning between different color media. In order to make a display device (such as an LCD monitor) sRGB-compatible, color temperature calibration becomes an extremely important issue for manufacturing of the display device.

Display principles of LCD monitors and CRT monitors are different, and mapping between LCD monitors and CRT monitors according to the sRGB specifications is typically considered useless. Therefore, regarding LCD monitors on the market, there are typical problems such as inaccurate color calibration/tuning, color deviation between gray levels, and even nonlinear luminance distribution of the gray levels. When a LCD monitor displays pure white, the color temperature of a lower gray level typically deviates to a higher color temperature in contrast to the color temperature of a higher gray level. For example, a color temperature exceeding 10000K may lead to blue-white color rather than pure white, causing inability to comply with the sRGB specifications since the color temperature of sRGB-compatible devices should be 6500K. According to the prior art, forcibly adjusting abnormal gray levels by manual processing can be applied to LCD monitors on a production line. However, the problem that different gray levels fail to correspond to the same color temperature may occur, probably causing erroneous hue mapping or color deviations.

### SUMMARY OF THE INVENTION

It is an objective of the claimed invention to provide color adjustment methods and related devices.

According to one embodiment of the claimed invention, a color adjustment method for adjusting a second color characteristic of a second display device according to a first color characteristic is disclosed. The first color characteristic comprises the relationship between a plurality of sets of first digital color channel values and a plurality of sets of first chromaticity coordinate values, where each set of first digital color channel values are respectively corresponding to a plurality of color channels. The second color characteristic comprises the relationship between a plurality of sets of second digital color channel values and a plurality of sets of second chromaticity coordinate values, where each set of second digital color channel values are respectively corresponding to a plurality of color channels of the second display device. The color adjustment method comprises: utilizing the sets of first digital color channel values as the sets of second digital color channel values; utilizing the sets of first chromaticity coordinate values as the sets of second chromaticity coordinate values; and adjusting the Gamma characteristic of the second display device according to the first color characteristic, so that the second color characteristic is substantially equivalent to the first color characteristic.

According to one embodiment of the claimed invention, a color adjustment method for adjusting a color characteristic of a display device is disclosed. The color adjustment method comprises respectively utilizing a plurality of sets of digital color channel values to drive the display device, where each set of digital color channel values are respectively corresponding to a plurality of color channels of the display device. The color adjustment method further comprises regarding each set of digital color channel values of at least one portion of the sets of digital color channel values: respectively utilizing a plurality of candidate Gamma characteristics to drive the display device, and measuring colors displayed by the display device to generate a plurality of sets of candidate chromaticity coordinate values corresponding to the candidate Gamma characteristics; and selecting a set of target chromaticity coordinate values according to the sets of candidate chromaticity coordinate values, and determining a Gamma characteristic corresponding to the set of digital color channel values according to a target Gamma characteristic corresponding to the set of target chromaticity coordinate values within the candidate Gamma characteristics to adjust the color characteristic of the display device. The color characteristic comprises the relationship between the sets of digital color channel values and a plurality of corresponding sets of target chromaticity coordinate values.

According to one embodiment of the claimed invention, a color adjustment device for adjusting a color characteristic of a display device is disclosed. The color adjustment device comprises a processing circuit for respectively utilizing a plurality of sets of digital color channel values to drive the display device, where each set of digital color channel values are respectively corresponding to a plurality of color channels of the display device. Regarding each set of digital color channel values of at least one portion of the sets of digital color channel values, the processing circuit respectively utilizes a plurality of candidate Gamma characteristics to drive the display device. The color adjustment device further comprises a calorimeter, coupled to the processing circuit and the display device. Regarding the set of digital color channel values, the colorimeter measures colors displayed by the display device to generate a plurality of sets of candidate chromaticity coordinate values corresponding to the candidate Gamma characteristics. The processing circuit selects a set of target chromaticity coordinate values according to the sets of candidate chromaticity coordinate values, and determines a Gamma characteristic corresponding to the set of digital color channel values to adjust the color characteristic of the display device according to a target Gamma characteristic corresponding to the set of target chromaticity coordinate values within the candidate Gamma characteristics. The color characteristic comprises the relationship between the sets of digital color channel values and a plurality of corresponding sets of target chromaticity coordinate values.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a color adjustment device for adjusting a color characteristic of a display device according to one embodiment of the present invention.

FIG. 2 illustrates mathematical models utilized by a color adjustment method according to one embodiment of the present invention.

FIG. 3 illustrates a plurality of sets of target chromaticity coordinate values selected by a color adjustment method while tuning the Gamma characteristic of a display device according to one embodiment of the present invention

### DETAILED DESCRIPTION

The present invention may utilize automatic processing to solve color deviation problems between different gray levels of a display device. In one embodiment, after utilizing a calorimeter to measure colors displayed on a screen or a display panel of the display device to generate chromaticity coordinate values, and after completing measurement corresponding to designated gray level numbers, an sRGB transform matrix and a look-up table (LUT) of corresponding Gamma characteristics can be generated automatically. For simplicity, in the following, “colors displayed on a screen or a display panel of the display device” will be referred to as “colors displayed by the display device”. The LUT represents tone curves corresponding to red, green, and blue color channels, respectively.

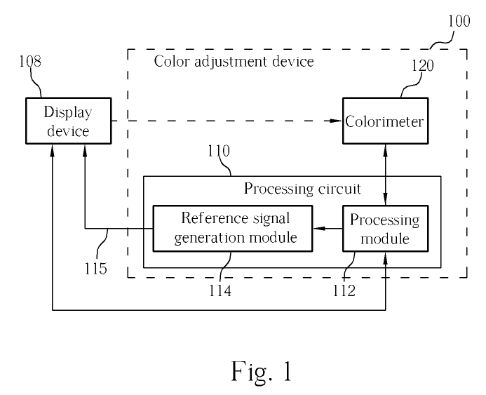

Please refer to FIG. 1 showing a diagram of a color adjustment device 100 for adjusting a color characteristic of a display device 108 according to one embodiment of the present invention, where the display device 108 of this embodiment is a liquid crystal display (LCD) monitor. The color adjustment device 100 comprises a processing circuit 110 and a calorimeter 120, where the processing circuit 110 comprises a processing module 112 and a reference signal generation module 114. The processing module 112 can be implemented by utilizing a processor executing a program code, or by utilizing hardware architecture directly. The reference signal generation module 114 drives the display device 108 to display colors according to the control of the processing module 112. In addition, the calorimeter 120 is an instrument that is easy to derive from the market for measuring the colors displayed by the display device 108. In general, there are different kinds of chromaticity coordinates that can represent the color characteristic of the display device 108, for example, the chromaticity coordinate (X, Y, Z) or the chromaticity coordinate (Y, x, y), where X, Y, and Z in the chromaticity coordinate (X, Y, Z) mentioned above are referred to as the CIE tristimulus values, and the chromaticity coordinate (Y, x, y) comprises the luminance Y and the CIE-1931 chromaticity coordinate (x, y). The calorimeter 120 will generate corresponding chromaticity coordinate values according to the chromaticity coordinate selected by the user. The transformation between different chromaticity coordinates (X, Y, Z), (Y, x, y), . . . , etc. are well known by those skilled in the art. As long as the implementation of the present invention is not hindered, the present invention is not limited to utilizing a certain chromaticity coordinate.

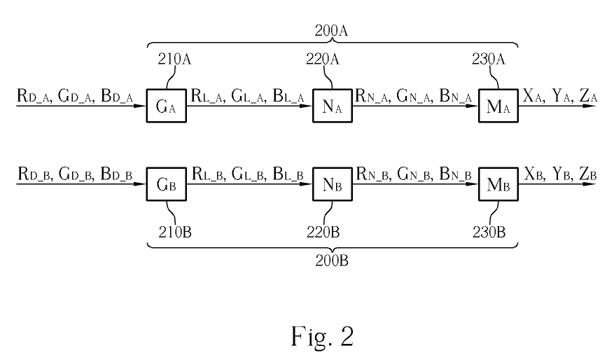

FIG. 2 illustrates mathematical models utilized by a color adjustment method according to one embodiment of the present invention, where the color adjustment method may adjust a color characteristic 200B of a display device B according to a color characteristic 200A. According to this embodiment, the color characteristic 200A is the color characteristic of a display device A. The color adjustment method can be applied to the embodiment shown in FIG. 1 (where the display device 108 shown in FIG. 1 can be utilized for representing the display device A or the display device B), and described as follows:

The digital color channel values (R_{D}_A, G_{D}_A, B_{D}_A) shown in FIG. 2 respectively correspond to red value(s), green value(s), and blue value(s) of color channels of the display device A (i.e. R/G/B color channels of the display device A), where R_{D}_A, G_{D}_A, B_{D}_A are variables, and (R_{D}_A, G_{D}_A, B_{D}_A) shown in FIG. 2 may represent any set of a plurality of sets of digital color channel values (R_{D}_A, G_{D}_A, B_{D}_A). If the display device 108 shown in FIG. 1 represents the display device A, then the digital color channel values (R_{D}_A, G_{D}_A, B_{D}_A) represent the digital color channel values generated by the display device 108 while sampling a set of reference signals 115 respectively corresponding to the red, green, and blue color channels. The set of reference signals 115 are transmission media that the processing module 112 in the processing circuit 110 utilizes for transmitting the digital color channel values (R_{D}_A, G_{D}_A, B_{D}_A) to the display device 108. That is, the processing module 112 controls the reference signal generation module 114 to generate the set of reference signals 115 corresponding to the digital color channel values (R_{D}_A, G_{D}_A, B_{D}_A), so the display device 108 may sample the set of reference signals 115 to derive the digital color channel values (R_{D}_A, G_{D}_A, B_{D}_A).

As shown in FIG. 2, the color characteristic 200A comprises the relationship 210A between the sets of digital color channel values (R_{D}_A, G_{D}_A, B_{D}_A) and a plurality of sets of linear color channels values (_{RL}_A, _{GL}_A, _{BL}_A), the relationship 220A between the sets of linear color channels values (_{RL}_A, _{GL}_A, _{BL}_A) and a plurality of sets of normalized color channels values (R_{N}_A, G_{N}_A, B_{N}_A), and the relationship 230A between the sets of normalized color channels values (R_{N}_A, G_{N}_A, B_{N}_A) and a plurality of sets of chromaticity coordinate values (X_{A}, Y_{A}, Z_{A}). In this embodiment, transform functions G_{A}, N_{A}, and M_{A}⁻¹ can be utilized for representing the relationships 210A, 220A, and 230A, where the arrows shown in FIG. 2 can be changed to be reversed, and transform functions G_{A}⁻¹, N_{A}⁻¹, and M_{A}⁻¹ can be utilized for representing the reversed operations corresponding to the transform functions G_{A}, N_{A}, and M_{A}, respectively.

The transform function G_{A} represents the Gamma characteristic of the display device A, so the relationship of 210A shown in FIG. 2 can also be referred to as the Gamma characteristic 210A. According to this embodiment, the transform function G_{A} is implemented by utilizing the LUT mentioned above. In addition, the transform function N_{A} represents a normalization operation, and the transform function M_{A} represents the display characteristic corresponding to (R_{N}_A, G_{N}_A, B_{N}_A) within the display device A. If the display device 108 shown in FIG. 1 represents the display device A, then the chromaticity coordinate values (X_{A}, Y_{A}, Z_{A}) may represent the chromaticity coordinate values generated by the calorimeter 120 while measuring the colors displayed by the display device A. In a special case of the mathematical models shown in FIG. 2, the transform function N_{A} can be omitted. That is, in a special case, performing the normalization operation is not required, so the transform function M_{A} may directly convert the linear color channels values (R_{L}_A, G_{L}_A, B_{L}_A) into the chromaticity coordinate values (X_{A}, Y_{A}, Z_{A}). Regarding deriving the color characteristic 200B of the display device B, similar descriptions of the lower half of the mathematical models shown in FIG. 2 are not repeated hereafter.

Here, the display device A can be considered as a golden sample, and the display device B can be considered as a product manufactured during a mass production phase. In order to adjust the color characteristic 200B of the display device B to be substantially equivalent to the color characteristic 200A of the display device A, the processing circuit 110 drives the display device A according to the sets of digital color channel values (R_{D}_A, G_{D}_A, B_{D}_A), and measures the colors displayed by the display device A to generate the sets of chromaticity coordinate values (X_{A}, Y_{A}, Z_{A}), where the sets of chromaticity coordinate values (X_{A}, Y_{A}, Z_{A}) are respectively corresponding to the sets of digital color channel values (R_{D}_A, G_{D}_A, B_{D}_A). In addition, the LUT values corresponding to the transform function G_{A} in the LUT can be derived from the display device A, that is, the LUT values can be preset in a LUT device positioned in the display device A. In this embodiment, the transform functions N_{A} and M_{A} are individual characteristics of the display device A, and can not be derived directly from any component within the display device A. Similarly, the transform functions N_{B} and M_{B} are individual characteristics of the display device B, and can not be derived directly from any component within the display device B, neither. This embodiment utilizes the sets of digital color channel values (R_{D}_A, G_{D}_A, B_{D}_A) as the sets of digital color channel values (R_{D}_B, G_{D}_B, B_{D}_B) and further utilizes the sets of chromaticity coordinate values (X_{A}, Y_{A}, Z_{A}) as the sets of chromaticity coordinate values (X_{B}, Y_{B}, Z_{B}), to generate the LUT values corresponding to the transform function G_{B} in the LUT within the display device B. As a result, the color adjustment device 100 adjusts the Gamma characteristic 210B of the display device B according to the color characteristic 200A, in order to adjust the color characteristic 200B.

According to this embodiment, the color adjustment method may first respectively set the initial values of the LUT values in the LUT of the display device B as a plurality of predetermined values. In addition, the color adjustment method may apply an increment or a decrement to an initial value of one of the LUT values, in order to generate a candidate LUT value and then check whether (and how much) the candidate LUT value matches the mathematical models shown in FIG. 2. Regarding each set of digital color channel values (R_{D}_B, G_{D}_B, B_{D}_B), the color adjustment method of this embodiment tunes the LUT values in the LUT of the display device B by selecting a best matching one (i.e. the one that matches the mathematical models shown in FIG. 2 best) from a plurality of candidate LUT values. According to a variation of the embodiment mentioned above, the color adjustment method may set the transform functions N_{A} and M_{A} to be equivalent to the transform functions N_{B} and M_{B} respectively, and change the arrows of the lower half of the mathematical models shown in FIG. 2 to be reversed. As a result, the transform functions G_{A}⁻¹, N_{A}⁻¹, and M_{A}⁻¹ can be utilized for representing the relationships 210B, 220B, and 230B, respectively. In this situation, the initial values of the LUT values in the display device B mentioned above can be respectively set as the corresponding LUT values in the display device A. Similar descriptions of this variation are not repeated here.

In another embodiment of the present invention, the color characteristic 200A can be the color characteristic of a virtual display device A′, for example, the color characteristic complying with the sRGB specifications. As a result, the transform functions G_{A}, N_{A}, and M_{A} within the color characteristic 200A are all known already. In addition, the transform functions G_{A}⁻¹, N_{A}⁻¹, and M^{A}⁻¹ can be utilized for representing the relationships 210B, 220B, and 230B, respectively. In this situation, the initial values of the LUT values in the display device B mentioned above can be set as a plurality of LUT values corresponding to the transform function G_{A} respectively. Again, similar descriptions of this embodiment are not repeated here.

According to another embodiment of the present invention, the sets of linear color channels values (R_{L}_A, G_{L}_A, B_{L}_A) and the sets of normalized color channels values (R_{N}_A, G_{N}_A, B_{N}_A) can be derived from the display device A. That is, this embodiment may derive the characteristics of the transform functions N_{A} and M_{A} by utilizing the sets of linear color channels values (R_{L}_A, G_{L}_A, B_{L}_A), the sets of normalized color channels values (R_{N}_A, G_{N}_A, B_{N}_A), and the sets of chromaticity coordinate values (X_{A}, Y_{A}, Z_{A}). In addition, the display device B comprises a control unit (not shown) for controlling according to a plurality of control parameters, where the plurality of control parameters are utilized for adjusting the characteristics of the transform functions N_{B} and M_{B}. This embodiment may generate or adjust the plurality of control parameters corresponding to the characteristics of the transform functions N_{B} and M_{B} in the display device B by utilizing the sets of digital color channel values (R_{D}_A, G_{D}_A, B_{D}_A) as the sets of digital color channel values (R_{D}_B, G_{D}_B, B_{D}_B), and by utilizing the sets of chromaticity coordinate values (X_{A}, Y_{A}, Z_{A}) as the sets of chromaticity coordinate values (X_{B}, Y_{B}, Z_{B}). As a result, the color adjustment device 100 may set the plurality of control parameters in the display device B according to the sets of linear color channels values (R_{L}_A, G_{L}_A, B_{L}_A), the sets of normalized color channels values (R_{N}_A, G_{N}_A, B_{N}_A), the sets of digital color channel values (R_{D}_B, G_{D}_B, B_{D}_B), and/or the sets of chromaticity coordinate values (X_{B}, Y_{B}, Z_{B}), in order to adjust the sets of linear color channels values (R_{L}_B, G_{L}_B, B_{L}_B) and the sets of normalized color channels values (R_{N}_B, G_{N}_B, B_{N}_B), so that the color characteristic 200B is substantially equivalent to the color characteristic 200A. As a result, the color adjustment device 100 adjusts the relationships 220B and 230B according to the color characteristic 200A to adjust the color characteristic 200B.

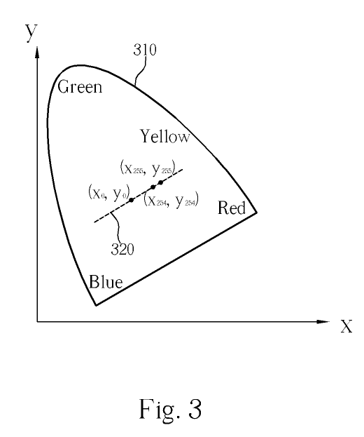

FIG. 3 illustrates a plurality of sets of target chromaticity coordinate values (x₂₅₅, y₂₅₅), (x₂₅₄, y₂₅₄), . . . , and (x₀, y₀) selected by a color adjustment method while tuning the Gamma characteristic of a display device according to one embodiment of the present invention. The color adjustment method can be applied to the embodiment shown in FIG. 1. According to the tuning related descriptions of the LUT values in the LUT of the display device B mentioned above, the color adjustment method is described as follows:

According to the characteristic of the CIE-1931 chromaticity coordinate (x, y), colors such as red, yellow, green, blue, and white are respectively located at the lower right portion, the upper right portion, the upper left portion, the lower left portion, and the central portion within the area enclosed by the curve 310. In addition, within different kinds of white that are respectively corresponding to different color temperatures, those belonging to higher color temperatures are located at the left-central portion, while those belonging to lower color temperatures are located at the right-central portion. In this embodiment, the display device 108 represents the display device B. The processing circuit 110 may respectively utilize 256 sets of digital color channel values (255, 255, 255), (254, 254, 254), . . . , and (0, 0, 0) to drive the display device B, and the sets of target chromaticity coordinate values (x₂₅₅, y₂₅₅), (x₂₅₄, y254), . . . , and (x₀, y₀) respectively represent the chromaticity coordinate values of the 256 gray levels displayed by the display device B according to the 256 sets of digital color channel values after the Gamma characteristic 210B is adjusted, where the LUT for representing the Gamma characteristic 210B comprises a plurality of sets of LUT values (R_{L255}, G_{L255}, B_{L255}), (R_{L254}, G_{L254}, B_{L254}), . . . , and (R_{L0}, G_{L0}, B_{L0}) respectively corresponding to the digital color channel values (255, 255, 255), (254, 254, 254), . . . , and (0, 0, 0).

The processing module 112 in the processing circuit 110 may determine the slope and the location of a direct line 320 by adjusting the LUT values (R_{L255}, G_{L255}, B_{L255}) and (R_{L0}, G_{L0}, B_{L0}), and then adjust the LUT values (R_{L254}, G_{L254}, B_{L254}), (R_{L253}, G_{L253}, B_{L253}), . . . , and (R_{L1}, G_{L1}, B_{L1}) according to the order of the gray levels, so that the sets of target chromaticity coordinate values may distribute along the direct line 320 according to the corresponding gray level's order of the sets of target chromaticity coordinate values (i.e. according to the ranking of the corresponding gray levels). Regarding each set of digital color channel values within the digital color channel values (254, 254, 254), (253, 253, 253), . . . , and (1, 1, 1), for example, (254, 254, 254), the processing circuit 110 drives the display device B by respectively utilizing a plurality of candidate Gamma characteristics, and the colorimeter 120 measures colors displayed by the display device B to generate a plurality of sets of candidate chromaticity coordinate values (x, y) corresponding to the candidate Gamma characteristics. The processing circuit 110 selects the target chromaticity coordinate values (x₂₅₄, y₂₅₄) according to the sets of candidate chromaticity coordinate values (x, y), and determines a Gamma characteristic corresponding to the digital color channel values (254, 254, 254) according to a target Gamma characteristic corresponding to the target chromaticity coordinate values (x₂₅₄, y₂₅₄) within the candidate Gamma characteristics, in order to adjust the color characteristic 200B. The color characteristic 200B of this embodiment further comprises the relationship 240B between the sets of chromaticity coordinate values (X_{B}, Y_{B}, Z_{B}) and a plurality of sets of chromaticity coordinate values (Y_{B}, x_{B}, Y_{B}), where (x_{B}, Y_{B}) is the chromaticity coordinate values (x, y) shown in FIG. 3.

In this embodiment, the candidate Gamma characteristics are respectively a plurality of sets of candidate LUT values. For example, the initial values of the LUT values (R_{L254}, G_{L254}, B_{L254}) are (250, 252, 251 ), the processing circuit 110 respectively tunes R_{L254}, G_{L254}, and B_{L254} to generate 7³ sets of candidate LUT values (R_{L254}′, G_{L254}′, B_{L254}′); wherein: R_{L254}′=247, 248, . . . , or 253; G_{L254}′=249, 250, . . . , or 255; and B_{L254}′=248, 249, . . . , or 254. The processing circuit 110 drives the display device B by respectively utilizing the 7³ sets of candidate LUT values, and the colorimeter 120 measures the colors displayed by the display device B to generate the sets of candidate chromaticity coordinate values (x, y) corresponding to the 7³ sets of candidate LUT values (i.e. the 7³ sets of candidate chromaticity coordinate values (x, y) in this embodiment). As a result, according to a set of target LUT values corresponding to the target chromaticity coordinate values (x₂₅₄, y254) out of the 7₃ sets of candidate LUT values, the processing circuit 110 determines a set of LUT values corresponding to the digital color channel values (254, 254, 254) within the LUT (i.e. the set of target LUT values in this embodiment), in order to adjust the color characteristic 200B. According to this embodiment, the processing module 112 in the processing circuit 110 may select the set of target LUT values from the 7³ sets of candidate LUT values according to some rules.

According to the distance between a specific set of candidate chromaticity coordinate values within the 7³ sets of candidate chromaticity coordinate values and a set of target chromaticity coordinate values corresponding to another set of digital color channel values, the processing module 112 may determine whether to select the specific set of candidate chromaticity coordinate values as the set of target chromaticity coordinate values. For example, during the process of selecting the target chromaticity coordinate values (x₂₅₄, y₂₅₄), if the distance between a specific set of candidate chromaticity coordinate values and the target chromaticity coordinate values (x₂₅₅, y₂₅₅) is the shortest among others, the processing module 112 selects the specific set of candidate chromaticity coordinate values as the target chromaticity coordinate values (x₂₅₄, y₂₅₄). In another example, during the process of selecting the target chromaticity coordinate values (x₂₅₃, y₂₅₃), if the distance between a specific set of candidate chromaticity coordinate values and the target chromaticity coordinate values (x₂₅₅, y₂₅₅) is the shortest among others, the processing module 112 selects the specific set of candidate chromaticity coordinate values as the target chromaticity coordinate values (x₂₅₃, y₂₅₃). In another example, during the process of selecting the target chromaticity coordinate values (x₂₅₃, y₂₅₃), if the distance between a specific set of candidate chromaticity coordinate values and the target chromaticity coordinate values (x₂₅₄, y₂₅₄) is the shortest among others, the processing module 112 selects the specific set of candidate chromaticity coordinate values as the target chromaticity coordinate values (x₂₅₃, y₂₅₃).

Further taking the process of selecting the target chromaticity coordinate values (x₂₅₄, y₂₅₄) as an example, the processing module 112 may determine whether to select the specific set of candidate chromaticity coordinate values as target chromaticity coordinate values (x₂₅₄, y₂₅₄) according to the angle between two direct lines out of the direct line passing through the points respectively represented by a specific set of candidate chromaticity coordinate values within the 7³ sets of candidate chromaticity coordinate values and the target chromaticity coordinate values (x₂₅₅, y255), the direct line passing through the points respectively represented by the specific set of candidate chromaticity coordinate values and the target chromaticity coordinate values (x₀, y₀), and the direct line passing through the points respectively represented by the target chromaticity coordinate values (x₂₅₅, y₂₅₅) and the target chromaticity coordinate values (x₀, y₀), or according to the slopes of the two direct lines mentioned above. By comparing any two angles or any two slopes, the processing module 112 may make the target chromaticity coordinate values (x₂₅₄, y₂₅₄) to be substantially located at the direct line 320 and arranged between the target chromaticity coordinate values (x₂₅₅, y₂₅₅) and the target chromaticity coordinate values (x₀, y₀) according to the corresponding gray level's order of the target chromaticity coordinate values (x₂₅₄, y₂₅₄) (i.e. according to the ranking of the corresponding gray level 254).

In addition, taking the process of selecting the target chromaticity coordinate values (x₂₅₄, y₂₅₄) as an example, the processing module 112 may select the target chromaticity coordinate values (x₂₅₄, y₂₅₄) according to a luminance value L₂₅₄′ corresponding to a specific set of candidate chromaticity coordinate values within the 7³ sets of candidate chromaticity coordinate values and a luminance value L₂₅₅ corresponding to the target chromaticity coordinate values (x₂₅₅, y₂₅₅). In this embodiment, if the luminance value L₂₅₄′ is not less than the luminance value L₂₅₅, the processing module 112 will not select the specific set of candidate chromaticity coordinate values as the target chromaticity coordinate values (x₂₅₄, y₂₅₄). As a result, the processing module 112 is capable of controlling the distribution of the luminance value L₂₅₄, L₂₅₃, . . . and L₁ corresponding to the target chromaticity coordinate values (x₂₅₄, y₂₅₄), (x₂₅₃, y₂₅₃), . . . , and (x₁, y₁). In this embodiment, the luminance values can be derived by converting the luminance Y.

According to another embodiment of the present invention, the processing circuit 110 further controls the accuracy of the distribution of the luminance values L₂₅₄, L₂₅₃, . . . and L₁ according to the following equation:
(L_{K-L}_{D})<L_{K}<(L_{K}+L_{D});

where 0<K <255 and L_{D}=(L_{K+1}+L_{K-1}) * P. Here, P is an accuracy parameter. In this embodiment, P=10%.

According to a variation of the embodiment shown in FIG. 1, the reference signal generation module 114 can be installed or positioned within the display device 108.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A color adjustment method for adjusting a second color characteristic of a second display device according to a first color characteristic, the first color characteristic comprising the relationship between a plurality of sets of first digital color channel values and a plurality of sets of first chromaticity coordinate values, each set of first digital color channel values respectively corresponding to a plurality of color channels, the second color characteristic comprising the relationship between a plurality of sets of second digital color channel values and a plurality of sets of second chromaticity coordinate values, each set of second digital color channel values respectively corresponding to a plurality of color channels of the second display device, the color adjustment method comprising:
utilizing the sets of first digital color channel values as the sets of second digital color channel values;
utilizing the sets of first chromaticity coordinate values as the sets of second chromaticity coordinate values; and
adjusting the Gamma characteristic of the second display device according to the first color characteristic, so that the second color characteristic is substantially equivalent to the first color characteristic.

2. The color adjustment method of claim 1, wherein the first color characteristic comprises the relationship between the sets of first digital color channel values and a plurality of sets of first linear color channels values and the relationship between the sets of first linear color channels values and the sets of first chromaticity coordinate values, the second color characteristic comprises the relationship between the sets of second digital color channel values and a plurality of sets of second linear color channels values and the relationship between the sets of second linear color channels values and the sets of second chromaticity coordinate values, and the adjusting step adjusts the relationship between the sets of second digital color channel values and the sets of second linear color channels values by adjusting the Gamma characteristic.

3. The color adjustment method of claim 2, wherein the relationship between the sets of first linear color channels values and the sets of first chromaticity coordinate values comprises the relationship between the sets of first linear color channels values and a plurality of sets of first normalized color channels values and the relationship between the sets of first normalized color channels values and the sets of first chromaticity coordinate values, and the relationship between the sets of second linear color channels values and the sets of second chromaticity coordinate values comprises the relationship between the sets of second linear color channels values and a plurality of sets of second normalized color channels values and the relationship between the sets of second normalized color channels values and the sets of second chromaticity coordinate values.

4. The color adjustment method of claim 3, wherein the step of adjusting the Gamma characteristic of the second display device according to the first color characteristic further comprises:
according to the sets of first linear color channels values, the sets of first normalized color channels values, the sets of second digital color channel values, and/or the sets of second chromaticity coordinate values, adjusting the sets of second linear color channels values, so that the second color characteristic is substantially equivalent to the first color characteristic.

5. The color adjustment method of claim 2, wherein the step of adjusting the Gamma characteristic of the second display device according to the first color characteristic further comprises:
according to the sets of first linear color channels values, the sets of second digital color channel values, and/or the sets of second chromaticity coordinate values, adjusting the sets of second linear color channels values, so that the second color characteristic is substantially equivalent to the first color characteristic.

6. The color adjustment method of claim 1, wherein the first color characteristic complies with sRGB specifications.

7. The color adjustment method of claim 1, wherein the first color characteristic is the color characteristic of a first display device, and the color adjustment method further comprises:
driving the first display device according to the sets of first digital color channel values, and measuring the colors displayed by the first display device to generate the sets of first chromaticity coordinate values, wherein the sets of first chromaticity coordinate values are respectively corresponding to the sets of first digital color channel values, and each set of first digital color channel values are respectively corresponding to the color channels of the first display device.

8. A color adjustment method for adjusting a color characteristic of a display device, the color adjustment method comprising:
(a) respectively utilizing a plurality of sets of digital color channel values to drive the display device, each set of digital color channel values respectively corresponding to a plurality of color channels of the display device; and
(b) regarding each set of digital color channel values of at least one portion of the sets of digital color channel values:
(b-1) respectively utilizing a plurality of candidate Gamma characteristics to drive the display device, and measuring colors displayed by the display device to generate a plurality of sets of candidate chromaticity coordinate values corresponding to the candidate Gamma characteristics; and
(b-2) selecting a set of target chromaticity coordinate values according to the sets of candidate chromaticity coordinate values, and determining a Gamma characteristic corresponding to the set of digital color channel values according to a target Gamma characteristic corresponding to the set of target chromaticity coordinate values within the candidate Gamma characteristics to adjust the color characteristic of the display device;
wherein the color characteristic comprises the relationship between the sets of digital color channel values and a plurality of corresponding sets of target chromaticity coordinate values.

9. The color adjustment method of claim 8, wherein the color characteristic comprises the relationship between the sets of digital color channel values and a plurality of sets of linear color channels values and the relationship between the sets of linear color channels values and the sets of target chromaticity coordinate values, and step (b-2) adjusts the relationship between the set of digital color channel values and a set of linear color channels values by determining the Gamma characteristic corresponding to the set of digital color channel values.

10. The color adjustment method of claim 8, wherein step (b) adjusts the color characteristic, so that the color characteristics complies with sRGB specifications.

11. The color adjustment method of claim 8, wherein the Gamma characteristics of the display device are controlled by utilizing at least one look-up table (LUT), and step (b-1) further comprises:
respectively utilizing a plurality of sets of candidate LUT values representing the candidate Gamma characteristics to drive the display device, and measuring the colors displayed by the display device to generate the sets of candidate chromaticity coordinate values corresponding to the sets of candidate LUT values;
wherein step (b-2) determines a set of LUT values corresponding to the set of digital color channel values within the LUT according to a set of target LUT values corresponding to the set of target chromaticity coordinate values within the sets of candidate LUT values, in order to adjust the color characteristic of the display device.

12. The color adjustment method of claim 11, wherein step (b) further comprises:
applying an increment or a decrement to an initial value of a LUT value within the set of LUT values to generate a candidate LUT value of a set of candidate LUT values within the sets of candidate LUT values.

13. The color adjustment method of claim 11, wherein step (b) further comprises:
adjusting the LUT according to the order of a plurality of gray levels converted by the LUT.

14. The color adjustment method of claim 11, wherein step (b-2) further comprises:
according to the distance between a specific set of candidate chromaticity coordinate values within the sets of candidate chromaticity coordinate values and a set of target chromaticity coordinate values corresponding to another set of digital color channel values, determining whether to select the specific set of candidate chromaticity coordinate values as the set of target chromaticity coordinate values corresponding to the set of digital color channel values.

15. The color adjustment method of claim 11, wherein the sets of digital color channel values comprise a first set of digital color channel values, a second set of digital color channel values, and a third set of digital color channel values, step (b) is executed regarding the first set of digital color channel values, and step (b-2) further comprises:
determining whether to select the specific set of candidate chromaticity coordinate values as the set of target chromaticity coordinate values corresponding to the first set of digital color channel values according to the angle between two direct lines out of a direct line passing through the points respectively represented by a specific set of candidate chromaticity coordinate values within the sets of candidate chromaticity coordinate values and a set of target chromaticity coordinate values corresponding to the second set of digital color channel values, a direct line passing through the points respectively represented by the specific set of candidate chromaticity coordinate values and a set of target chromaticity coordinate values corresponding to the third set of digital color channel values, and a direct line passing through the points respectively represented by the set of target chromaticity coordinate values corresponding to the second set of digital color channel values and the set of target chromaticity coordinate values corresponding to the third set of digital color channel values, or according to the slopes of the two direct lines.

16. The color adjustment method of claim 11, wherein step (b-2) further comprises:
selecting the set of target chromaticity coordinate values according to a luminance value corresponding to a specific set of candidate chromaticity coordinate values within the sets of candidate chromaticity coordinate values, and a luminance value corresponding to a set of target chromaticity coordinate values corresponding to another set of digital color channel value.

17. The color adjustment method of claim 8, wherein step (a) further comprises:
generating at least one reference signal to drive the display device to display colors;
wherein the reference signal corresponds to a set of digital color channel values within the sets of digital color channel values utilized while driving the display device.

18. A color adjustment device for adjusting a color characteristic of a display device, the color adjustment device comprising:
a processing circuit for respectively utilizing a plurality of sets of digital color channel values to drive the display device, each set of digital color channel values being respectively corresponding to a plurality of color channels of the display device, wherein regarding each set of digital color channel values of at least one portion of the sets of digital color channel values, the processing circuit respectively utilizing a plurality of candidate Gamma characteristics to drive the display device; and
a calorimeter, coupled to the processing circuit and the display device, wherein regarding the set of digital color channel values, the calorimeter measures colors displayed by the display device to generate a plurality of sets of candidate chromaticity coordinate values corresponding to the candidate Gamma characteristics;
wherein the processing circuit selects a set of target chromaticity coordinate values according to the sets of candidate chromaticity coordinate values, and determines a Gamma characteristic corresponding to the set of digital color channel values to adjust the color characteristic of the display device according to a target Gamma characteristic corresponding to the set of target chromaticity coordinate values within the candidate Gamma characteristics, and the color characteristic comprises the relationship between the sets of digital color channel values and a plurality of corresponding sets of target chromaticity coordinate values.

19. The color adjustment device of claim 18, wherein the processing circuit further comprises:
a reference signal generation module, for generating at least one reference signal to drive the display device to display colors;
wherein the reference signal is corresponding to a set of digital color channel values utilized while driving the display device within the sets of digital color channel values.

20. The color adjustment device of claim 19, wherein the reference signal generation module is installed or positioned within the display device.
